(19) United States
(12) Patent Application Publication
(10) Pub. No.: US 2026/0242233 A1
(43) Pub. Date: Aug. 20, 2026

(54) MULTI-STAGE STEAM AND CO2 CARBONATION CURING

(71) Applicant: CARBONBUILT, INC., El Segundo, CA (US)

(72) Inventors: Iman MEHDIPOUR, Los Angeles, CA (US); Gaurav SANT, Los Angeles, CA (US)

(21) Appl. No.: 19/543,107

(22) Filed: Feb. 18, 2026

Related U.S. Application Data
(60) Provisional application No. 63/760,275, filed on Feb. 19, 2025.

(51) Int. Cl. C01F 11/18; B01D 53/34; B01D 53/62; B01D 53/75; B01D 53/83; B01D 53/96; C01B 32/50

(52) U.S. Cl. CPC C01F 11/181; B01D 53/346; B01D 53/62; B01D 53/75; B01D 53/83; B01D 53/96; C01B 32/50; B01D 2258/0283

(57) ABSTRACT

The carbonation process includes providing steam in contact with a calcium-containing reactant in a curing chamber in a first stage; and providing carbon dioxide (CO₂) in contact with the calcium-containing reactant in the curing chamber in a second stage, wherein the first stage is an open loop and the second stage is a closed loop.

### CROSS-REFERENCE TO RELATED APPLICATIONS

This application claims priority to, and the benefit of, U.S. Provisional Patent Application No. 63/760,275, filed on Feb. 19, 2025, the entire contents of which are herein incorporated by reference in its entirety for all purposes.

### FIELD

The present disclosure concerns carbon dioxide (CO₂) mineralization and a system for carbonation curing system of concrete, as well as methods of manufacturing carbonated concrete components.

### BACKGROUND OF THE INVENTION

Industrial CO₂ production is an environmental concern. For example, the manufacture of the cement binder for concrete accounts for 5% of global CO₂ emissions from all industrial process and fossil-fuel combustion in 2013. Greenhouse gases such as CO₂ absorb solar energy, known as the Greenhouse Effect, and result in climate change events. Rising levels of carbon dioxide in the atmosphere have been associated with global warming.

Conventional carbonation curing chambers are primarily designed in a closed loop process in which curing chambers are filled with CO₂-containing gas and pressurized. To enhance carbonation kinetics, such curing systems require a separate drying step and/or external heating systems such as heating jackets to evaporate water from the concrete and in order to improve gas transport. Such processing conditions result in longer/extended curing cycles and larger system process energy demand.

What are needed are processes to enhance both CO₂ uptake and CO₂ conversion efficiency through carbonation reactors to make useful concrete products.

### SUMMARY OF THE INVENTION

The present carbonation system provides a CO₂-enriched steam curing process in an open loop first stage incorporating CO₂-steam and a closed loop second stage incorporating a CO₂-enriched stream. The two-stage CO₂-enriched steam curing process enhances carbonation kinetics and accelerates carbonation curing. For example, once the reaction shifts to diffusion-controlled regime, the rising CO₂ % enhances carbonation kinetics and carbonation strengthening.

The carbonation system shortens the overall curing cycle by reducing resting time (e.g., pre-carbonation hydration) and steaming time (e.g., post-carbonation hydration). Steaming can enhance hydration kinetics of cement and lime kiln dust (LKD) during carbonation. For example, the LKD can be hydrated prior to carbonation. The steam flow rate can be adjusted to regulate concrete temperature rise and inward water vapor transport. The water vapor introduced by steam can slow down carbonation kinetics by filing pores and increasing moisture saturation level. As a result, the present process can control the rate of the carbonation to optimize the concrete product.

In an embodiment, the carbonation process includes providing steam in contact with a calcium-containing reactant in a curing chamber in a first stage; and providing carbon dioxide (CO₂) in contact with the calcium-containing reactant in the curing chamber in a second stage, wherein the first stage is an open loop and the second stage is a closed loop.

### BRIEF DESCRIPTION OF DRAWINGS

FIG. 1 is a diagram of the carbonation system including a closed loop and open loop.

### DETAILED DESCRIPTION OF THE INVENTION

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

As used herein, “carbonated materials” refers to materials made by contacting CO₂ to a calcium-containing reagent, alkaline-rich mineral material, aluminosilicate mineral material, or any combination thereof. Carbonated materials include, but are not limited to calcite, vaterite, aragonite, magnesite, amorphous calcium carbonate, and combination thereof. Carbonated materials may include oxides, hydroxides, carbonates, silicates, aluminates, sulfites, sulfates, chlorides, nitrates, or nitrites of calcium and/or magnesium and/or other uni-/multi-valent elements, or any combination thereof so long as the oxides, hydroxides, silicates, aluminates, sulfites, sulfates, chlorides, nitrates, or nitrites of calcium and/or magnesium also include a carbonate phase.

As used herein, “alkaline-rich mineral materials” refers to materials which include Ca and/or Mg and which are used in industrial processes. Alkaline-rich mineral materials include, but are not limited to, Ca(OH)₂, lime kiln dust, lime, hydrated lime, cement kiln dust, calcium-rich coal combustion residues, slag, off-spec fly ashes, biomass ashes, fluidized bed combustion ashes, circulating fluidized bed ashes, off-spec limes, mineral sorbent/scrubbing residues comprising anhydrous CaO and/or Ca(OH)₂, and combinations thereof. The alkaline-rich mineral materials may further comprise at least one of oxides, hydroxides, carbonates, silicates, sulfites, sulfates, chlorides, nitrates, or nitrites of calcium and/or magnesium, or any combination thereof. Alkaline-rich mineral materials may also include virgin Ca(OH)₂.

As used herein, the term “material performance of a carbonated concrete composite” is defined as porosity, compressibility, and/or other mechanical or strength measurement (e.g., Young's modulus, yield strength, ultimate strength, fracture point, etc.).

As used herein, the term “negatively affecting the material performance” refers to a material performance which is reduced in magnitude by a factor of 10 or more.

As used herein, the term “uniform material performance of a carbonated concrete component” refers to substantially uniform material properties throughout the concrete component. That is, there are no significant gradients or variations in material performance from one area of the concrete composite to another area of the concrete composite.

As used herein, the term “material performance gradient” refers to a gradients in CO₂ content, porosity and/or compressibility (i.e., physical properties of materials) in the carbonated concrete composite. Gradients in CO₂ content and physical properties of materials may result from non-uniform carbonation reaction and/or non-uniform temperature and relative humidity in the curing chamber. In various embodiments, for uniform material performance, the porosity, measured as a volume percent, and/or the compressibility does not vary by more than ±25% over a concrete volume unit of 1 m³. In various embodiments, for uniform material performance, the porosity and/or compressibility does not vary by more than ±20% over a concrete volume unit of 1 m³. In various embodiments, for uniform material performance, the porosity and/or compressibility does not vary by more than ±15% over a concrete volume unit of 1 m³. In various embodiments, for uniform material performance, the porosity and/or compressibility does not vary by more than ±10% over a concrete volume unit of 1 m³. In various embodiments, for uniform material performance, the porosity and/or compressibility does not vary by more than ±10% over a concrete volume unit of 10 cm³. In various embodiments, for uniform material performance, the porosity and/or compressibility does not vary by more than ±5% over a concrete volume unit of 10 cm³. In various embodiments, for uniform material performance, the porosity and/or compressibility does not vary by more than ±1% over a concrete volume unit of 10 cm³. For example, the compressibility may be measured according to ASTM C140 under uniaxial monotonic displacement-controlled loading using a hydraulic jack with a capacity of 800 kN. In this example, the carbonated concrete composite does not have a material performance gradient if the compressibility does not vary by more than ±10%, preferably ±5% over a concrete volume unit of 10 cm³.

Fly ash, as used herein, includes an amount of CaO and an amount of aluminosilicate. Often the CaO is chemically inaccessible and shielded in the interior or core of the fly ash particles by a passivated layer.

Lime, as used herein, includes CaO. Impure lime may include other impurities other than CaO.

As used herein, “aluminosilicate mineral materials” refers to materials which include silica and/or alumina in the form of amorphous or crystalline or combination thereof. Aluminosilicate mineral materials include, but are not limited to, coal combustion residues, slag, off-spec fly ashes, biomass ashes, fluidized bed combustion ashes, circulating fluidized bed ashes, calcium rich fly ashes, calcium-poor fly ashes, ponded ashes, landfilled ashes, bottom ashes, flue gas ashes, and combinations thereof. The aluminosilicate mineral materials may further comprise at least one of oxides, hydroxides, carbonates, silicates, sulfites, sulfates, chlorides, nitrates, or nitrites of calcium and/or magnesium, or any combination thereof.

As used herein, the phrase “mainly calcium carbonates and alumina-silica gel,” refers to a product mixture that is more than 50% by weight calcium carbonate. In some embodiments, the mixture is more than 90% by weight calcium carbonate. In some embodiments, including any of the foregoing, when two starting materials are used, such as LKD and fly ash, in which one starting material includes Al phases, Si phases, or both, then both calcium carbonate and alumina-silica carbonates may form during carbonation curing. In some other embodiments, when one starting material, such as portlandite, is used and which only includes Ca(OH)₂, then calcium carbonate may form but alumina-silica carbonates will not form during carbonation curing.

As used herein, the phrase “alkaline-rich mineral materials that are at least partially carbonated,” refers to alkaline-rich mineral materials that have some amount of calcium carbonate on their surface. A partially carbonated alkaline-rich mineral materials includes an alkaline-rich mineral material that has a discontinuous coating of calcium carbonate on its surface. A fully carbonated alkaline-rich mineral materials includes an alkaline-rich mineral material that has a continuous coating of calcium carbonate on its surface. Both partially carbonated alkaline-rich mineral materials and fully carbonated alkaline-rich mineral materials include an unreacted core. The partial or full carbonation of the alkaline-rich mineral materials refers to the extent that a carbonate coating is present on the alkaline-rich mineral materials.

As used herein, “alumina-silicate gel,” refers to a type of geopolymer and includes an activated form of alkaline materials. The activated form includes materials which are formed by hydration and/or pozzolanic reactions. For example, hydraulic/pozzolanic activation of hydraulic-carbonating binder systems in concrete generates calcium silicate and calcium aluminate hydrates, carboaluminate phases, alumina-silica gel as well as AFt and AFm phases. Alumina-silica gel is a product that forms from the carbonation of alkaline-aluminosilicate or calcium silicate mixture.

Herein, a “residue” is an alkaline-rich mineral material or an aluminosilicate material which has been already contacted with CO₂-containing gas stream, for example, as a sorbent or scrubber in a CO₂-flue gas or it can be an aluminosilicate mineral material that has been obtained as solid waste through industrial process such as coal combustion residues. An alkaline-rich residue may include hydrated lime, lime kiln dust, off-spec limes, mineral sorbent/scrubbing residues, or a combination thereof. An aluminosilicate residue may include coal combustion residues, slag, off-spec fly ashes, biomass ashes, fluidized bed combustion ashes, circulating fluidized bed ashes, calcium rich fly ashes, calcium-poor fly ashes, ponded ashes, landfilled ashes, bottom ashes, flue gas ashes, and combinations thereof. A residue may be referred to in the art as a mineral sorbent.

As used herein, the term “green body” refers to a concrete precursor. Green bodies and concrete products are used interchangeably herein, for example when describing a carbonation reaction in which a CO₂-containing gas is in contact with materials in a carbonation chamber. Those materials may be referred to interchangeably as green bodies and concrete products.

As used herein, the term “rate of carbonation” refers to the rate which CO₂ is consumed. To quantify the carbonation kinetics, the time-CO₂ uptake profiles are fitted to an equation of the form

$$C ( t ) = C ( {t}_{u} ) ( 1 - exp [ ( - {k}_{carb} t ) / C ( {t}_{u} ) ] ) \qquad ( Eq . 6 )$$

where k_{carb} is the apparent carbonation rate constant and C(tᵤ) is the ultimate CO₂ uptake at the end of carbonation curing duration.

As used herein, “gas velocity,” refers to the property of a gas that characterizes is flow rate and flow direction.

For example, a carbonation at or above 0.005 per hour means that k_{carb} is a value 0.005 or greater. This would include, but is not limited to, k_{carb} of 0.05, or 0.5, or 1, or 2. Herein, k_{carb} is equal to, or greater than, 0.05, and equal to, or less than, 3. In certain embodiments, k_{carb} may be equal to, or greater than, 0.05, and equal to, or less than, 2. In other embodiments, k_{carb} is about 0.05. In still other embodiments, k_{carb} is 0.1. In some other embodiments, k_{carb} is 0.2. In yet other embodiments, k_{carb} is 0.3. In certain other embodiments, k_{carb} is 0.4. In other embodiments, k_{carb} is 0.5. In some other embodiments, k_{carb} is 0.6. In some embodiments, k_{carb} is 0.7. In some other embodiments, k_{carb} is 0.8. In certain embodiments, k_{carb} is 0.9. In certain other embodiments, k_{carb} is 1.0. In still other embodiments, k_{carb} is 1.1. In some other embodiments, k_{carb} is 1.2. In other embodiments, k_{carb} is 1.3. In yet other embodiments, k_{carb} is 1.4. In some other embodiments, k_{carb} is 1.5. In other embodiments, k_{carb} is 1.6. In certain embodiments, k_{carb} is 1.7. In certain other embodiments, k_{carb} is 1.8. In another embodiments, k_{carb} is 1.9. In yet another embodiments, k_{carb} is 2.0. In still another embodiments, k_{carb} is 2.1. In certain other embodiments, k_{carb} is 2.2. In other embodiments, k_{carb} is 2.3. In some other embodiments, k_{carb} is 2.4. In yet other embodiments, k_{carb} is 2.5. In certain embodiments, k_{carb} is 2.6. In certain other embodiments, k_{carb} is 2.7. In other embodiments, k_{carb} is 2.8. In some other embodiments, k_{carb} is 2.9. In yet other embodiments, k_{carb} is 3.0.

As used herein, the “reaction medium” is the environment in which the alkaline-rich mineral material or aluminosilicate or calcium aluminosilicate mineral materials or any combination thereof is exposed to CO₂ during fractionation and/or grinding.

As used herein, the “mineral carbonation reactor” is a reactor used to produce calcium carbonate by exposing, in a confined space, alkaline-rich mineral materials to a CO₂-containing gas stream.

As used herein, “stirring carbonation reactor” is a reactor used to produce calcium carbonate by exposing, in a confined space, alkaline-rich mineral materials to a CO₂-containing gas stream while also stirring the alkaline-rich mineral materials.

As used herein, the term “flow-through chamber,” refers to a chamber through which gas may be flowed continuously and at ambient pressure.

As used herein, the term “ambient pressure,” refers to atmospheric pressure on planet Earth.

As used herein, the term “CO₂-containing flue gas stream,” refers to a gas stream effluent from a source which includes carbon dioxide (CO₂) such as industrial CO₂-containing gas stream, dilute flue gas stream, a concentrated CO₂ gas stream, biomass-derived CO₂ or atmospherically derived CO₂.

As used herein, the term “CO₂-containing gas” refers to any gas stream that includes carbon dioxide (CO₂).

As used herein, the term “air curing” refers to drying to adjust moisture content of concrete prior to carbonation curing process.

As used herein, the term “a carbonated concrete composite,” refers to a carbonated concrete object (e.g., a building material) made from early-age (e.g., fresh) concrete that is then contacted with a CO₂-containing curing gas having a suitable CO₂ concentration.

As used herein, the term “ambient pressure,” refers to atmospheric pressure on planet Earth. In an embodiment, ambient pressure is 1 atm.

As used herein, the extent of carbonation conversion and carbonation rate refers to the weight of calcium carbonate formed from the starting material, e.g., OPC or LKD.

As used herein, the term “open loop” refers to low CO₂ exhaust is released or vented out of a chamber, and “closed loop” refers to the CO₂ from the chamber being recirculated to allow the stream to be mixed with incoming CO₂ rich stream to conserve expensive CO₂ if a DAC-like CO2 source needs to be used.

### Embodiments

Provided herein are carbonation systems useful for contacting concrete materials with carbon dioxide (CO₂) gas and steam under ambient pressure. This contacting causes a carbonation reaction in which CO₂ forms carbonation materials, such as, but not limited to, calcium carbonate (CaCO₃). The carbonation systems are useful for strengthening concrete and concrete components by hardening the concrete and concrete components via carbonation and hydration reactions which occur in the carbonation system.

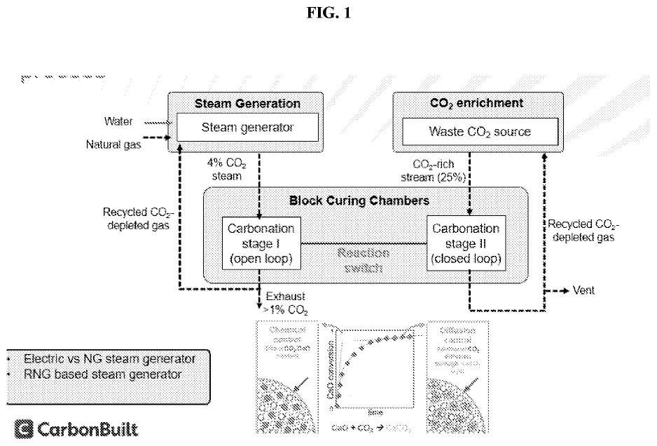

The carbonation system can include a two-stage carbonation process to enhance carbonation kinetics and accelerate carbonation curing. As shown in FIG. 1, the carbonation process can include providing steam in contact with a calcium-containing reactant in a first stage curing chamber to generate a partially hydrated calcium-containing reactant; and providing carbon dioxide (CO₂) in contact with the partially hydrated calcium-containing reactant in a second stage curing chamber. In an example, the first stage can be an open loop and the second stage can be a closed loop. The process can include recirculated CO₂ in the first stage, second stage, or both.

The CO₂-enriched steam curing process enhances both hydration and carbonation reactions. Mixing CO₂ with steam forms a CO₂-dissolved stream (carbonate species), which results in more efficient carbonation. The carbonation favored reaction slows down subsequent hydration reactions due to the barrier layer formation. Once the reaction shifts to a diffusion-controlled regime, the rising CO₂ % enhances carbonation kinetics and carbonation strengthening.

The process can switch from the first stage to the second stage as a function of the extent of the carbonation, and/or as a function of time that the calcium-containing reactant is exposed. The time of the switch from the first stage to the second stage is dependent on the composition of the calcium-containing reactant.

In an example, the first stage can be an open loop wherein CO₂-enriched steam from a steam generator is directed to a first stage carbonation chamber, wherein CO₂-depleted gas can exit the first stage carbonation chamber. In an example, the CO₂-depleted gas can be recirculated back to the steam generator. In an example, the CO₂-depleted gas is not recirculated back to the steam generator. A portion of the gas from the first stage carbonation chamber can exit as exhaust. For example, the exhaust amount of CO₂ in first stage of the carbonation process can be greater than 1%, greater than 2%, greater than 3%, or greater than 5% by volume. The steam generator can include an input of water in combination with gas provided from an electric generator, a natural gas steam generator, and/or a renewable natural gas generator.

The CO₂-enriched steam from the steam generator can be at least 1%, at least 2%, at least 3%, at least 4%, at least 5%, at least 6%, at least 8%, or at least 10% CO₂ by volume. In an example, the CO₂-enriched steam from the steam generator can be less than 25%, less than 20%, less than 15%, less than 10%, less than 5%, or less than 3% CO₂ by volume. For example, the CO₂-enriched steam from the steam generator can be 1% to 25%, 2% to 20%, 3% to 10%, 2% to 5%, 3% to 5% CO₂ by volume. In an example, the amount of CO₂ in the first stage is 0.1% to 10% by volume. In an example, the amount of CO₂ in the first stage is 1% to 5% by volume. In an example, the amount of CO₂ in the first stage is 4% by volume.

The second stage can be a closed loop wherein a CO₂-rich stream from a CO₂ waste source is directed to a second stage carbonation chamber, wherein the CO₂-depleted gas exiting the second stage carbonation chamber can be recycled back to the CO₂ waste source. The CO₂ in the second stage carbonation chamber can include an effluent from an industrial CO₂-containing gas stream, dilute flue gas stream, a concentrated CO₂ gas stream, a commercially available CO₂ source, liquefied CO₂, atmospherically-derived CO₂ (direct air capture), biomass-derived CO₂, or combinations thereof. In an example, the CO₂ in the second stage carbonation chamber is provided from a CO₂ enrichment process. In an example, the CO₂ in the second stage carbonation chamber is provided from a waste CO₂ source. In an example, the CO₂ in the second stage carbonation chamber is provided from a flue gas source.

The CO₂-rich stream can be at least 1%, at least 5%, at least 10%, at least 15%, at least 20%, at least 25%, at least 30%, or at least 35% CO₂ by volume. In an example, the CO₂-riched stream can be less than 50%, less than 45%, less than 15%, less than 30%, less than 25%, or less than 20% CO₂ by volume. For example, the CO₂-riched stream can be 1% to 35%, 10% to 30%, 15% to 25%, 20% to 25%, or 20% to 30% CO₂ by volume.

In an example, the amount of CO₂ in the second stage is greater than the amount of CO₂ in the first stage. In an example, the amount of CO₂ in the second stage is 10% to 40% by volume. In an example, the amount of CO₂ in the second stage is 15% to 30% by volume. In an example, the amount of CO₂ in the second stage is 25% by volume.

The calcium-containing reactant can be selected from the group consisting of calcium oxide, materials that include calcium oxide, industrial waste, mineral residues, alkaline-rich mineral materials, recycled crushed concrete, slag, lime, hydrated lime, lime kiln dust, cement kiln dust, off-spec limes, sorbent/scrubbing residues, ladle slag, iron slag, coal combustion residues, fly ashes, ponded ashes, landfilled ashes, biomass ashes, fluidized bed combustion ashes, circulating fluidized bed ashes, and combinations thereof. In an example, the calcium-containing reactant can be selected from the group consisting of calcium oxide, industrial waste, mineral residues, alkaline-rich mineral materials, recycled crushed concrete, slag, lime, hydrated lime, lime kiln dust, cement kiln dust, fly ashes, and combinations thereof. In an example, the calcium-containing reactant can be, alkaline-rich mineral materials.

The calcium-containing reactant can be shaped into forms including, but not limited to, blocks, cylinders, slabs, or beams.

The carbonation process can produce carbonated materials by contacting CO₂ to an alkaline-rich mineral material or an aluminosilicate mineral material or any combination thereof. The carbonated materials may include oxides, hydroxides, carbonates, silicates, aluminates, sulfites, sulfates, chlorides, nitrates, or nitrites of calcium and/or magnesium and/or other uni-/multi-valent elements, or any combination thereof so long as the oxides, hydroxides, silicates, aluminates, sulfites, sulfates, chlorides, nitrates, or nitrites of calcium and/or magnesium also include a carbonate phase. In an example, the carbonation process can produce calcium carbonate (CaCO₃).

The first stage open loop CO₂-steam can include circulation without conditioning of temperature and relative humidity. The second stage closed loop CO₂-enriched stream can include circulation without conditioning of temperature and relative humidity. In an example, the first step of the open loop does not have a CO₂ capture target. In an example, the closed loop step can include a CO₂ capture target.

In some embodiments, the relative humidity in the first stage, second stage, or both, of CO₂ contacting gas stream ranges from about 10% to about 90%. In some embodiments, including any of the foregoing, the temperature of contacting CO₂-containing gas stream in the first stage, second stage, or both, ranges from 20° C. to about 150° C., 30° C. to about 100° C., 40° C. to about 70° C., 50° C. to about 60° C., and/or 55° C. to about 65° C. In some embodiments, including any of the foregoing, the CO₂ concentration of the CO₂-containing flue gas ranges from 5% to about 100% by volume. The flow rate of the CO₂-containing gas stream can be 1-5 standard liters per minute (SLPM).

In some embodiments, including any of the foregoing, the reaction residence time ranges from 5 minutes to about 24 hours. For example, the first stage can have a residence time of greater than 5 minutes and less than 12 hours, less than 6 hours, less than 3 hours, or less than 1 hour. For example, the second stage can have a residence time of greater than 5 minutes and less than 24 hours, less than 12 hours, less than 6 hours, or less than 1 hour. Herein, the reaction residence time is the time that the alkaline-rich mineral materials are in contact with the CO₂-containing gas.

In an example, when a fly ash-LKD blend is treated with the present two-stage carbonation process, the resulting strength of the carbonated product 1800-2000 psi. In contrast, when the same fly ash-LKD blend is treated in a single stage process, the resulting strength of the carbonated product is 1500 psi.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A carbonation process, comprising:
providing steam in contact with a calcium-containing reactant in a first stage curing chamber in a first stage to produce a partially hydrated calcium-containing reactant, wherein the first stage is an open loop; and
providing carbon dioxide (CO₂) in contact with the partially hydrated calcium-containing reactant in a second stage curing chamber in a second stage, wherein the second stage is a closed loop wherein exhaust from the second stage curing chamber is recirculated to an input of CO₂ for the second stage curing chamber.

2. The carbonation process of claim 1, wherein the steam in the first stage further comprises CO₂.

3. The carbonation process of claim 2, wherein the amount of CO₂ in the first stage is 0.1% to 10% by volume.

4. The carbonation process of claim 2 or 3, wherein the amount of CO₂ in the first stage is 1% to 5% by volume.

5. The carbonation process of any one of claims 2-4, wherein the amount of CO₂ in the first stage is 4% by volume.

6. The carbonation process of any one of claims 2-5, further comprising exhausting an amount of CO₂ in the first stage that is greater than 1% by volume.

7. The carbonation process of any one of claims 1-6, wherein the concentration of CO₂ in the second stage is greater than the amount of CO₂ in the first stage.

8. The carbonation process of any one of claims 1-7, wherein the concentration of CO₂ in the second stage is 10% to 40% by volume.

9. The carbonation process of any one of claims 1-8, wherein the concentration of CO₂ in the second stage is 15% to 30% by volume.

10. The carbonation process of any one of claims 1-9, wherein the concentration of CO₂ in the second stage is 25% by volume.

11. The carbonation process of any one of claims 1-10, wherein the CO₂ in the second stage is provided from a CO₂ enrichment process.

12. The carbonation process of any one of claims 1-11, wherein the CO₂ in the second stage is provided from a waste CO₂ source.

13. The carbonation process of any one of claims 1-12, wherein the CO₂ in the second stage is provided from a flue gas source.

14. The carbonation process of any one of claims 1-13, wherein the steam in the first stage is provided from an electric generator, a natural gas steam generator, or a renewable natural gas generator.

15. The carbonation process of any one of claims 1-14, further comprising recirculating CO₂ in the first stage.

16. The carbonation process of any one of claims 1-15, wherein the calcium-containing reactant is shaped as a block.

17. The carbonation process of any one of claims 1-16, wherein the calcium-containing reactant is selected from the group consisting of calcium oxide, materials that include calcium oxide, industrial waste, mineral residues, alkaline-rich mineral materials, recycled crushed concrete, slag, lime, hydrated lime, lime kiln dust, cement kiln dust, off-spec limes, sorbent/scrubbing residues, ladle slag, iron slag, coal combustion residues, fly ashes, ponded ashes, landfilled ashes, biomass ashes, fluidized bed combustion ashes, circulating fluidized bed ashes, and combinations thereof.

18. The carbonation process of any one of claims 1-17, wherein the process changes from the first stage to the second stage when the carbonation of the calcium-containing reactant in the first stage is greater than a predetermined carbonation amount.

19. The carbonation process of any one of claims 1-17, wherein the process changes from the first stage to the second stage when the hydration of the calcium-containing reactant in the first stage is greater than a predetermined hydration amount.

20. The carbonation process of any one of claims 1-19, wherein the process produces calcium carbonate (CaCO₃).
